(19) United States
(12) Patent Application Publication
(10) Pub. No.: US 2005/0024551 A1
(43) Pub. Date: Feb. 3, 2005

(54) System and method for shielding a display

(76) Inventor: Amy E. Battles, Windsor, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/631,278

(22) Filed: Jul. 31, 2003

(51) Int. Cl. G02F 1/1333

(52) U.S. Cl. 349/58

(57) ABSTRACT

The present invention provides a system and method for shielding a display. Briefly described, one embodiment comprises a display shield coupled to a display enclosure wherein a display resides, so that the display shield may be selectively oriented in at least a first position covering the display, a second position shading the display and a third position retracted from the display.

### TECHNICAL FIELD

The present invention is generally related to shielding displays and, more particularly, is related to a system and method for shielding a display on an image capture device with a display shield.

### BACKGROUND

It is desirable to protect displays, such as displays found on cameras, when the display extends outward from the image capture a device. Furthermore, it is desirable to shade the display from directly incident light, thereby improving visibility of images displayed on the display. Liquid crystal displays (LCD) and light emitting diode (LED) displays may be particularly difficult to view when directly in sunlight or in other high ambient lighting conditions.

Shields, covers, hoods and the like are available to provide shading from indirect sunlight. Some covers may also be configured to cover the display when not in use, thereby providing physical protection to the display. However, such shields, covers or hoods may be in the way of a user during some operating conditions.

### SUMMARY

The present invention provides a system and method for shielding a display. Briefly described, one embodiment comprises a display shield coupled to a display enclosure wherein a display resides, so that the display shield may be selectively oriented in at least a first position covering the display, a second position shading the display and a third position retracted from the display.

Another embodiment comprises orienting a display shield in a first position, the first position covering the front of the display; orienting the display shield in a second position, the second position shading the display; and orienting the display shield in a third position, the third position retracting the display shield.

### BRIEF DESCRIPTION OF THE DRAWINGS

The components in the drawings are not necessarily to scale relative to each other. Like reference numerals designate corresponding parts throughout the several views.

FIG. 1 is a diagram illustrating a side view of one embodiment of an image capture device.

FIG. 2 is a diagram illustrating a front view of the embodiment of the image capture device.

FIGS. 3A-B are diagrams illustrating an embodiment of the shield unit.

FIG. 4 is a diagram illustrating an embodiment of the shield unit having a display shield, two members and two coupling members.

FIG. 5 is a diagram illustrating an embodiment of the shield unit that includes an auxiliary shade screen.

FIG. 6 is a diagram illustrating an embodiment of the shield unit that includes a pin such that the display shield may be rotated into a position desired by the user.

FIG. 7 is a diagram illustrating an embodiment of the display shield configured to be repositioned by sliding along a single track residing in the display enclosure.

FIG. 8 is a flowchart illustrating an embodiment of a method for adjusting position of the display shield.

### DETAILED DESCRIPTION

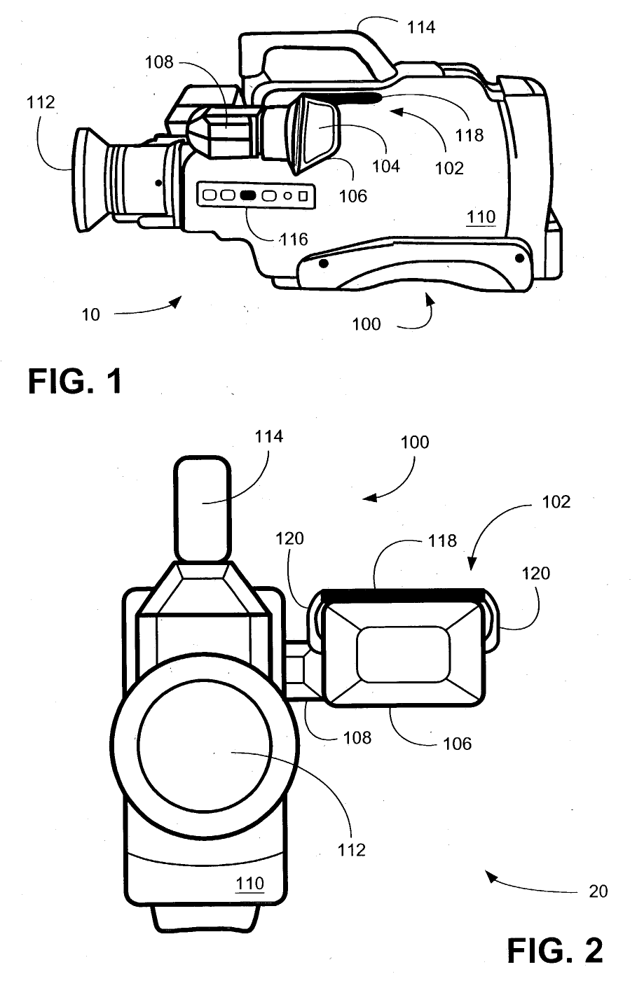

Embodiments of a display shield 118 (FIG. 1) are configured to be oriented with respect to a display 104 in at least three positions. A first position covers the display 104, thereby providing physical protection to, or shielding, the display 104. A second position provides shade, or shielding, from incident sunlight and other incident light sources to display 104, thereby improving visibility of images displayed on the display 104. A third position provides for placement of display shield 118 in a convenient retracted position when shield unit 102 is not being used for protecting or shading display 104.

FIG. 1 is a diagram illustrating a side view 10 of one form of an image capture device 100 embodying the present invention. FIG. 2 is a diagram illustrating a front view 20 of the image capture device 100 (FIG. 1). For convenience, the image capture device 100 is illustrated as a type of video image capture device. It is understood that embodiments of the present invention apply equally to other types of image capture devices. Furthermore, other embodiments apply to other electronic devices that employ a display, such as cellular telephones, personal device assistants, portable computers, table-top displays, televisions, radars, sonars and fish-finding devices.

Image capture device 100 includes shield unit 102, display 104, display enclosure 106, connector 108 and body 110. Connector 108 is configured, in one embodiment, to extend the display enclosure 106 outwardly from body 110. Embodiments of image capture device 100 also include lens 112, optional handle 114 and controls 116.

One embodiment of shield unit 102 includes display shield 118 and two attachment members 120 (FIG. 2). The attachment members 120 are configured to attach the display shield 118 to the display enclosure 106.

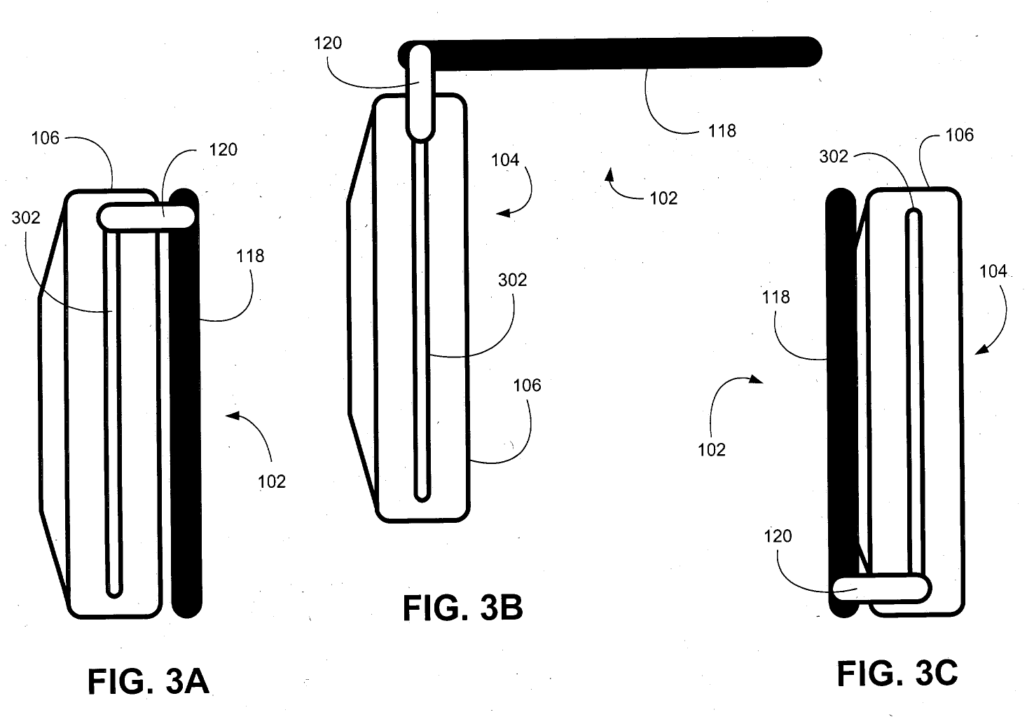

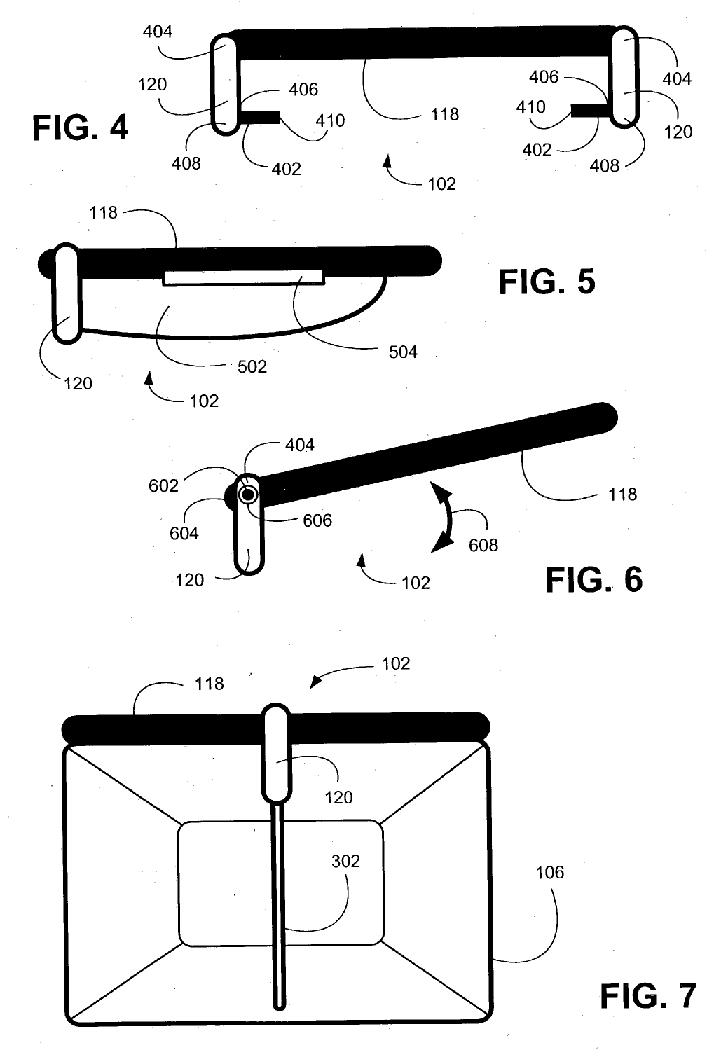

FIGS. 3A-C are diagrams illustrating an embodiment of the display shield 118. As illustrated in the side views of FIGS. 3A-3C, display shield 118 may be selectively oriented with respect to display 104 (FIG. 1) and display enclosure 106 in three positions. Display enclosure 106 includes a track 302. A coupling member 402 (FIG. 4) is coupled to attachment member 120 and is configured to slide within the track to provide position adjustment to display shield 118, as described in greater detail below. The opposing side (not shown) of display-enclosure 106 is similarly configured with another track. Accordingly, another coupling member on the opposing side of display shield 118 is configured to slide within the other track, thereby providing additional support for display shield 118.

In one embodiment, track 302 is recessed in the display enclosure 106. A recessed track 302 may be molded into the display enclosure 106 or may be added into a channel, groove or the like of the display enclosure 106. In another embodiment, track 302 is not recessed, but is raised even with or above the surface of the display enclosure 106.

FIG. 3A illustrates the display shield 118 in a first position that covers, or shields, the display 104, thereby providing physical protection to the display 104. For convenience, this first position is referred to as the “protecting” position. Accordingly, it is understood that the display shield 118 is large enough to cover at least the exposed area of display 104.

FIG. 3B illustrates the display shield 118 in a second position that shades, or shields, the display 104 from incident sunlight and other incident light sources, thereby improving visibility of images displayed on the display 104. For convenience, this second position is referred to as the “shading” position. Accordingly, it is understood that the display shield 118 is large enough to provide shade to at least some regions of display 104 which may be otherwise difficult to view when sunlight or another light is incident on display 104.

FIG. 3C illustrates the display shield 118 in a third position that is retracted so that the display shield 118 is not interfering with the viewing of display 104. For convenience, this third position is referred to as the “retracted” position. Accordingly, it is understood that the display shield 118 is small enough such that when in the retracted position, the display shield 118 does not interfere with the operation of the image capture device 100.

FIG. 4 is a diagram illustrating an embodiment of the shield unit 102 having a display shield 118, two attachment members 120 and two coupling members 402. For convenience, coupling members 402 are referred to hereinafter as “pins” 402. In one embodiment, the proximal ends 404 of attachment members 120 are rigidly attached to the ends of display shield 118 so that the attachment members 120 generally extend outward in a perpendicular direction from the display shield 118. The proximal ends 406 of pins 402 are rigidly attached to the distal ends 408 of attachment members 120 so that pins 402 generally extend outward from the attachment members 120 in a perpendicular direction, and such that pins 402 are generally pointed inwards toward each other.

The distal ends 410 of the pins 402 are configured to slideably couple to track 302 (FIGS. 3A-3C). Because the display shield 118, attachment members 120 and pins 402 are rigidly attached to each other as described above, the distal ends 410 of pins 402 remain within the tracks 302 as the display shield 118 is reoriented into the above-described positions illustrated in FIGS. 3A-3C.

In some embodiments, the distal ends 410 may include protrusions or the like that interlock with its respective track 302 so that the distal ends 410 do not slip out of the track 302. Distal ends 410 and recessed track 302 are, in one embodiment, configured to include a means to secure the position of the display shield 118 when the display shield 118 is oriented in one of the above-described positions. Any suitable apparatus employing a track, channel, groove or the like, and a corresponding coupling member 402 inserted into the track, channel, groove or the like, may be employed by embodiments of the present invention.

With reference to FIG. 3B illustrating the display shield 118 in the shading position, it is understood that the display shield 118 may be rotated in a clockwise manner to be repositioned in the protecting position illustrated in FIG. 3A. Furthermore, it is understood that the display shield 118 may be rotated in a counterclockwise manner, and then slid downward to the extent of the track 302, to be repositioned in the retracted position illustrated in FIG. 3C.

FIG. 5 is a diagram illustrating an embodiment of the shield unit 102 that includes an auxiliary shade screen 502. Auxiliary shade screen 502 is configured to extend generally downward, and/or outward, from the display shield 118 to provide additional shading from direct sunlight and other incident light on display 104. In one embodiment, auxiliary shade screen 502 is rigidly attached to display shield 118 and/or attachment member 120. In other embodiments, the auxiliary shade screen 502 is hinged with a hinge means 504 such that the auxiliary shade screen 502 may be repositioned as desired by the user. Other embodiments employ other types of adjustable coupling means 504 which couple the auxiliary shade screen 502 to display shield 118 or attachment member 120, such as bearings, ball and socket couplers, hinges or the like, to provide adjustment of the position of auxiliary shade screen 502.

FIG. 6 is a diagram illustrating an embodiment of the shield unit 102 that includes a pin 602 having one of its ends rigidly attached to and near the end 604 of display shield 118. When pin 602 is in the hole 606 disposed in the proximal end 404 of attachment member 120, display shield 118 may be selectably rotated about pin 602 into a selectable shading position desired by the user, thereby permitting selectable shading to the display. In another embodiment, pin 602 is rigidly attached to and extends outwardly from attachment member 120 such that a protruding end of the pin 602 is inserted into a mating recess on the display shield 118. In yet another embodiment, pin 602 is rigidly attached to and extends outwardly from display shield 118 such that the other end of the pin 602 is inserted into a mating recess on the attachment member 120. Thus, with these various embodiments, the display shield 118 may be moved to a desirable position by rotating the display shield about the pin 602, as shown, by direction arrow 608. Instead of the pin 602, other embodiments may employ other rotation means such as bearings, ball and socket couplers, hinges or the like generally at the location of pin 602, thereby coupling the display shield 118 and the attachment member 120 to permit rotation of the display shield 118 as shown by direction arrow 608.

FIG. 7 is a diagram illustrating an embodiment of the display shield 118 configured to be repositioned by sliding along a single track 302 residing in the display enclosure 106. In this embodiment, a single attachment member 120 couples the display shield 118 and the display enclosure 106, via a single track 302. For convenience, the track 302 is illustrated as residing approximately at the center of the display enclosure 106. It is understood that the track 302 may be located at any convenient location on the display enclosure 106, including one of the sides of the display enclosure 106.

In the above-described embodiments, shield unit 102, comprising at least member(s) 120 and display shield 118, may be fabricated from a single piece of material, such as molded or extruded plastic and/or metal. Other embodiments may comprise separate individual pieces attached together using any suitable means, such as screws, adhesive, clips, snaps, welds or the like.

Embodiments of shield unit 102 and/or display enclosure 106 may be comprised of any suitable material, such as plastics, resins, polymer compounds, metal or the like. Furthermore, different materials may be used for the individual components of shield unit 102 and/or display enclosure 106. Embodiments of shield unit 102 and/or display enclosure 106 may be fabricated in any desirable design, shape and/or color appealing to consumers.

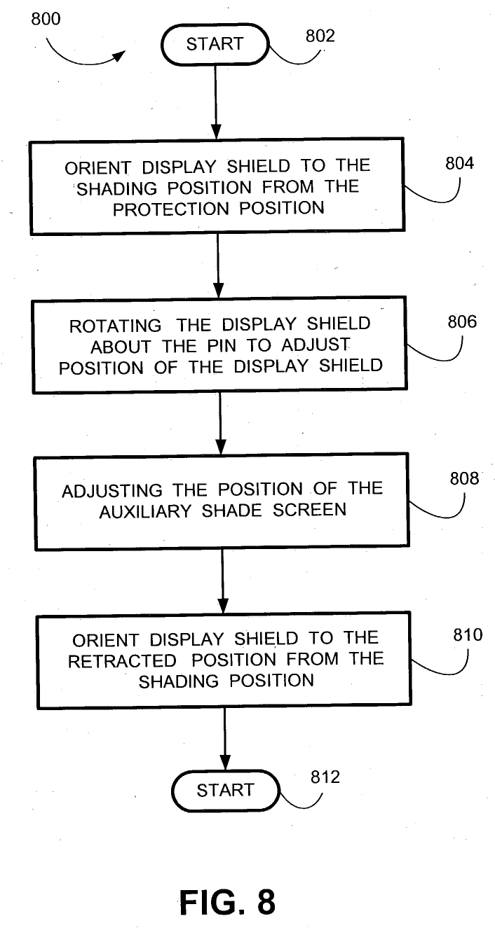

FIG. 8 is a flowchart illustrating an embodiment of a method for adjusting position of the display shield 118 (FIGS. 1-7). FIG. 8 shows a flow chart 800, illustrating operation of the display shield 118 (FIGS. 1-7). The flow chart 800 of FIG. 8 shows the architecture, functionality, and operation of an embodiment for implementing the shield unit 102 (FIG. 2) such that the display shield 118 may be oriented in at least three different positions, as described above.

Assuming that display shield 118 is initially in a position that protects the display 104 (FIG. 3A), the process begins at step 802. At step 804, the display shield 118 is oriented (moved) to a position that shades the display by sliding the attachment member 120 along recessed track 302, and by then rotating the display shield 118 to the position shown in FIG. 3B. At step 806, with embodiments employing a pin 602 (FIG. 6), the position of the display shield 118 is adjusted, by rotating the display shield 118 about pin 602, to adjust shading to display 104. With embodiments employing a position adjustable auxiliary shade screen 502 (FIG. 5), the position of auxiliary shade screen 502 is adjusted at step 808 to provide additional shading to display 104.

At step 810, the display shield 118 is oriented (moved) to a retracted position behind display enclosure 106 by rotating the display shield 118 counterclockwise by approximately ninety degrees (90°) and then by sliding the attachment member 120 downwardly along recessed track 302 to the position shown in FIG. 3C. The process ends at step 812.

It is understood that the above described process illustrates repositioning the display shield 118 from the protecting position, to the shading position to the retracted position. It is understood that the display shield 118 may be repositioned from any of the above-described current positions to another position by sliding attachment member 120 along recessed track 302.

It should be emphasized that the above-described embodiments are merely examples of implementations of the invention. Many variations and modifications may be made to the above-described embodiments. All such modifications and variations are intended to be included herein within the scope of this disclosure and protected by the following claims.

1. A shield unit comprising a display shield coupled to a display enclosure wherein a display resides, so that the display shield may be selectively oriented in at least a first position covering the display, a second position shading the display from incident light, and a third position retracted from the display.

2. The shield unit of claim 1, further comprising a coupling member coupled to the display shield, such that when the coupling member is disposed in a track residing in the display enclosure, the coupling member slides within the track so that the display shield may be slideably changed to at least the first position, the second position and the third position.

3. The shield unit of claim 2, wherein the coupling member comprises a pin, and wherein a portion of the pin is disposed within the track so that the pin slides within the track.

4. The shield unit of claim 2, further comprising a second coupling member coupled to the display shield, such that when the second coupling member is disposed in a second track residing in an opposing side of the display enclosure, the coupling member and the second coupling member slide within the track and the second track, respectively, so that the display shield may be selectively oriented in the first position, the second position and the third position.

5. The shield unit of claim 2, further comprising an attachment member rigidly attached to the display shield and rigidly attached to the coupling member.

6. The shield unit of claim 1, further comprising:
an attachment member rigidly attached the coupling member; and
a pin coupling the attachment member and the display shield so that the display shield may be changed from the second position to a fourth position when the display shield is rotated about the pin.

7. The shield unit of claim 1, further comprising at least one auxiliary shade screen coupled to the display shield, the auxiliary shade screen providing additional shading from incident light on the display.

8. A method comprising the steps of:
orienting a display shield in a first position, the first position covering the front of the display;
orienting the display shield in a second position, the second position shading the display from incident light; and
orienting the display shield in a third position, the third position retracting the display shield.

9. The method of claim 8, further comprising the step of rotating the display shield about a pin to orient the display shield in a fourth position.

10. A system comprising:
means for orienting a display shield in a first position, the first position covering the front of a display;
means for orienting the display shield in a second position, the second position shading the display from incident light; and
means for orienting the display shield in a third position, the third position retracting the display shield.

11. The system of claim 10, further comprising means for rotating the display shield about a pin to orient the display shield in a fourth position to permit selectable shading of the display.

12. The system of claim 10, further comprising means for sliding a coupling member along a track residing in a display enclosure wherein the display resides, the coupling member coupling the display shield and the display enclosure, such that a position of the display shield is adjustable to one of the first position, the second position and the third position.

13. A device comprising:
means for coupling a coupling member to a display shield; and
means for slideably coupling the coupling member to a track residing in a display enclosure to permit the display shield to be oriented in a protecting position covering the display, in a shading position shading the display from incident light, and in a retracted position locating the display shield behind the display.

14. The device of claim 13, further comprising a rotation means operable to permit the display shield to be rotated about the rotation means to a selectable shading position.

15. The device of claim 13, further comprising at least one auxiliary shade screen coupled to the display shield, the auxiliary shade screen providing additional shade from incident light on the display.

16. The device of claim 15, further comprising an adjustable coupling means coupling the auxiliary shade screen to the display shield such that a position of the auxiliary shade screen is adjustable.

17. A system comprising:
a display residing in a display enclosure; and
a display shield coupled to the display enclosure so that the display shield may be selectively oriented in at least a first position covering the display, a second position shading the display from incident light, and a third position retracted from the display.

18. The system of claim 17, further comprising an electronic device coupled to the display enclosure.

19. The system of claim 18, wherein the electronic device is an image capture device.

20. The system of claim 18, further comprising a connector that extends the display enclosure outwardly from the electronic device so that when the display shield is in the third position, the display shield is retracted in a position behind the display enclosure.
